(19) United States
(12) Patent Application Publication
(10) Pub. No.: US 2023/0302723 A1
(43) Pub. Date: Sep. 28, 2023

(54) METHOD AND 3D PRINTING SYSTEM FOR MANUFACTURING A PHYSICAL OBJECT

(71) Applicant: 3M INNOVATIVE PROPERTIES COMPANY, St. Paul, MN (US)

(72) Inventors: Malte Korten, Moorenweis (DE); Bastian P. Kirchner, Fuerstenfeldbruck (DE); Christian A. Richter, Feldafing (DE); Korbinian Gerlach, Gauting (DE); Rudolf Schmid, Eichenau (DE); Thomas K. Müller, Gauting (DE)

(21) Appl. No.: 18/006,631

(22) PCT Filed: Aug. 3, 2021
(86) PCT No.: PCT/IB2021/057098

§ 371 Date: Jan. 24, 2023

(30) Foreign Application Priority Data
Aug. 21, 2020 (EP) 20192103.8

(51) Int. Cl. B29C 64/129; B29C 64/286; B29C 64/245; B29C 64/255; B29C 64/393; B29C 64/182

(52) U.S. Cl. CPC B29C 64/129; B29C 64/286; B29C 64/245; B29C 64/255; B29C 64/393; B29C 64/182; B33Y 10/00

(57) ABSTRACT

A 3D printing system (10) for manufacturing at least one physical object comprises at least one reservoir (12) for receiving hardenable material; at least one light engine (22) configured to irradiate light onto a focal plane within the reservoir of the hardenable material to form a layer of hardened material; at least one build platform (18) for carrying the physical object to be manufactured; and a controller configured to select at least one or at least two optical resolutions from two or more optical resolutions available in the 3D printing system for irradiating the hardenable material based on a predetermined surface quality of the physical object to be manufactured.

In recent years, the use of additive manufacturing processes by means of 3D printing systems to manufacture physical objects has become more widespread. Thus, many industrial sectors use 3D printing systems to manufacture a wide range of products, ranging from everyday household items to more sophisticated items, such as items for medical use.

One available 3D printing system is referred to as Fused Deposition Modeling (FDM), in which a thermoplastic filament is fed through a hot extruder to soften the plastic. The softened plastic is then placed by a print head in layers to create a 3D printed object. Since FDM printing systems are generally inexpensive, they have become popular for home use. However, due to the relatively low achievable surface quality of the objects manufactured therewith, their use for industrial purposes is limited.

Higher surface qualities can be achieved by resin-based 3D printing systems, which include Stereolithography Apparatus (SLA) systems. Like FDM systems, SLA systems use an additive method to produce a physical object by applying a material to the physical object layer by layer.

SLA systems are based on the concept of curing a photosensitive polymer material, usually a liquid resin, by projecting a light pattern from a light module onto a layer of hardenable resin. The light module can be a laser or a digital projector, wherein the systems using digital projectors are often referred to as Digital Light Processing (DLP) systems.

DLP 3D printing systems typically use a digital micromirror device (DMD) comprising an array of rotating or swinging micromirrors that reflect the light onto the resin. Thus, the DMD is arranged in the optical path of the emitted light in order to achieve a desired light pattern on the layer of hardenable resin. Moreover, a liquid crystal display (LCD) arranged in the optical path of the light can be used instead of a DMD. Thus, 3D printing systems using such LCD technology are often referred to as LCD 3D printing systems, which are becoming more popular.

Laser SLA printers project one or a plurality of laser beams onto a surface of the physical object, while DLP printers project an entire image of one layer at once onto the physical object. Therefore, in general, DLP printers provide quicker curing of each layer, leading to shorter manufacturing processes. In both cases, the achievable surface quality of the manufactured object is determined primarily by the optical spot size either of the laser or the projector.

Depending on the intended use of the physical object and the surface quality required for the intended use, appropriate SLA and DLP printing systems are chosen based on the achievable surface quality of the respective printing system.

US 2018/056605 A1 (Chen Chao Shun et al.) describes a 3d-printing system including a build device and an optical projection engine. The optical projection engine has a zoom lens for projecting image beams with at least a first pixel size and a second pixel size on the build platform to cure the photocurable material.

WO 2016/164629 A1 (Trio Labs) describes a fabrication device comprising a build surface, a material delivery system, a first imaging component having a first resolution and a second imaging component having a second resolution, wherein the first and second imaging components are operable individually and in combination together.

DE 102 04 985 A1 (Beckmann) relates to a method for the production of a three-dimensional object on a building platform by solidifying a liquid material solidifiable under the action of electromagnetic or particle radiation in layers at the cross-section of the object to be produced with a defined layer thickness, using a depending on the cross-section of the object in the respective layer electronically controllable mask generating device for the selective projecting of radiation of controllable intensity onto the surface of the material to be exposed and a transparent plate for covering the material.

However, in many industrial sectors, there is need for a more flexible approach since the requirements for the objects to be manufactured often vary within the production of various products. Furthermore, there is a need for quicker manufacturing of objects in order to provide a more efficient production process.

Therefore, it is an object of the invention to provide an improved method of manufacturing a physical object.

This object is achieved by a method of manufacturing at least one physical object by means of a single 3D printing system. The method comprises the steps of:
a) providing at least one hardenable material;
b) selecting at least one or at least two optical resolutions from two or more optical resolutions available in the 3D printing system for irradiating the hardenable material;
c) selectively hardening a layer of the hardenable material by irradiating light having the at least one or at least two selected optical resolution provided by at least one light engine provided within the 3D printing system onto a focal plane within the hardenable material to form a layer of hardened material; and
d) displacing the layer of hardened material relative to the focal plane of the irradiated light.

Preferably, at least steps c) and d), preferably at least steps a), c) and d), more preferably steps b) to d) are repeated multiple times to manufacture the physical object.

In contrast to 3D printing systems known in the prior art, the method disclosed herein allows selection of at least one or at least two optical resolutions from two or more optical resolutions, whereas prior art 3D printing systems are provided with a single available optical resolution, thus limiting the use of the method to manufacturing with a single optical resolution. The selection of at least two optical solutions can sometimes be preferred.

Generally, a 3D printing system is chosen according to a user's requirements based on the highest required surface quality and required precision of objects to be manufactured. In this case, however, the optical resolution of the 3D printing system may be too high for certain products requiring a lower minimum surface quality. Higher optical resolutions can result in smaller light exposure areas compared with lower optical resolutions. Thus, using an optical resolution which is higher than the required minimum resolution for certain products unnecessarily decreases the maximum achievable build size of the physical object to be manufactured. Thus, this can limit the achievable build size and/or can increase the manufacturing time for larger products, thereby reducing the efficiency of manufacturing.

Moreover, several 3D printing systems each having a different optical resolution can be used. However, this increases the complexity within a production facility and increases the space and the build area required for manufacturing due to the high number of required 3D printing systems. Moreover, maintenance of a wide range of different 3D printing systems is required, which is time-consuming and less cost-effective.

Therefore, according to the method disclosed herein, selecting the at least one or at least two optical resolutions can be based on a predetermined surface quality of the at least one physical object to be manufactured.

This reduces the complexity within a production facility and decreases the space and the build area required for manufacturing multiple physical objects having different required surface qualities.

The focal plane is to be understood as the plane, in which the irradiated light is focused in the hardenable material, i.e. in which different light rays meet. Hence, the focal points of irradiated light lie in the focal plane.

The provided hardenable material can preferably be a resin. Moreover, the physical state of the hardenable material can preferably be liquid or alternatively a paste.

The method can also include providing a plurality of different hardenable materials, preferably of varying qualities. This includes providing a plurality of hardenable materials having different physical states, such as a paste and a liquid or a plurality of different pastes and/or a plurality of different liquids. Thus, a physical object can be manufactured using a variety of different hardenable materials. The different hardenable materials can be provided simultaneously or consecutively. Moreover, two or more hardenable materials can be provided simultaneously while at least one further hardenable material can be provided at a different time than the first two or more hardenable materials.

The hardenable material used, such as liquids and pastes, can in particular be characterized by their viscosity. Preferably, the viscosity of the hardenable material can range from 0.1 to 400 Pa*s, preferably from 0.1 to 200 Pa*s, more preferably from 0.1 to 100 Pa*s at 23° C. at a shear rate of 1 s⁻¹. The viscosity of the hardenable material can preferably be measured using a Physica MCR 301 Rheometer made by Anton Paar with a plate/plate or plate/cone geometry under a controlled shear rate at 23° C. The measurement can preferably substantially correspond to DIN 53018-1.

The hardenable material can be irradiated by the light having a certain energy dose. Preferably, the energy dose of the light emitted onto the hardenable material can be adjusted by adjusting the specific power of the light source in W/m² and/or by adjusting the exposure time of the light on the hardenable material. Preferably, the specific power of the light source can range from 0.1 W/m² to 100 W/m². Preferably, the exposure time can range from 1 second to 10 seconds. Thus, for instance, the specific power of the light source can be selected to be 10 W/m² and the exposure time can be selected to be 10 seconds. However, the specific power of the light source can be selected to be 100 W/m² and the exposure time can be selected to be 1 second. Thus, in general, preferably a higher exposure time can be combined with a lower specific light source power or a lower exposure time can be combined with a higher specific light source power. The selected amount of specific light source power and exposure time can preferably be selected based on the curing depth and/or on the properties of the hardenable material used, preferably including at least its viscosity and/or its specific heat capacity and/or its light absorption qualities.

The hardenable material can preferably be provided in a reservoir, also referred to as a vat. The level of hardenable material can preferably be kept constant or quasi-constant, for instance by continuously, or repeatedly at least after each hardening step, supplying the at least one hardenable material to the reservoir, for instance by means of a supplying device. Alternatively, the hardenable material can be supplied to the reservoir manually, for instance by the user.

Selecting at least one optical resolution from two or more optical resolutions available in the 3D printing system for irradiating the hardenable material can preferably be performed by a controller configured to execute such a selection. Preferably, a user can input a required surface quality of the at least one physical object to be manufactured. Based on the user's input, the controller can select at least one corresponding optical resolution from two or more optical resolutions which can achieve the required surface quality of the at least one physical object to be manufactured.

Within the context of the present disclosure, an optical resolution is generally related to a pixel size of the light irradiated onto the hardenable material. Thus, as the pixel size is reduced, the exposure area of the light on the hardenable material can be reduced. Hence, the amount of pixels per area, i.e. the exposure area, can be increased. This can enable a higher surface quality of a physical object to be achieved.

Reducing the pixel size and increasing the amount of pixels per area also increases the light energy per area. This increases the curing depth of the light irradiated onto the hardenable material, wherein the curing depth is to be understood as the maximum depth that the light allows to cure on a single layer. This enables, for instance, faster manufacturing of smaller parts with smaller build areas, such as single dental crowns.

Preferably, when the pixel size is reduced and the light energy per area is increased, the energy dose of the light irradiated onto the hardenable material can be adjusted by adjusting the specific power of the light source in W/m² and/or by adjusting the exposure time of the light on the hardenable material, as described above, in order to decrease the light energy exposed to the hardenable material to a desired level and to thereby counteract the increase in light energy when pixel sizes are reduced, for instance in order to maintain a substantially constant curing depth.

Vice versa, increasing the pixel size and thus reducing the amount of pixels per area generally leads to a lower surface quality of the physical object to be manufactured. However, in this case the exposure area of the light emitted onto the hardenable material is larger compared to smaller pixel sizes.

Therefore, by selecting and adjusting the optical resolution of the 3D printing system from a plurality of available optical resolutions within a single 3D printing system, different desired surface qualities can be achieved by a single 3D printing system. This allows flexible and efficient manufacturing processes of a wide range of objects or various required surface qualities.

According to the method disclosed herein, the pixel size of the irradiated light can preferably be selected and adjusted in a range from 0.75 μm to 100 μm, preferably from 10 μm to 100 μm, more preferably from 20 μm to 80 μm, most preferably from 30 to 70 μm.

The surface quality of the at least one physical object to be manufactured can preferably be determined based on the surface roughness of the physical object, i.e. the size of steps of the hardened material on the outer surface of the physical object after being manufactured. Preferably, the surface roughness is determined for a surface extending along the z-axis. Preferably, the surface roughness is determined for a plurality of surfaces extending along the z-axis. Preferably, the surface roughness is determined for a plurality of surfaces along more than one axis, for instance along 2 or 3 axes. Preferably, the surface roughness can be a mean value of all or at least a plurality of measured surfaces. This surface roughness can, for example, be determined based on known roughness parameters, such as root mean square deviation Rq, mean roughness Ra, mean roughness depth Rz and/or root mean square slope Rsq.

A preferred method of measuring the surface quality of a manufactured physical object is by using a confocal laser scanning microscope (CLSM), such as a Keyence VK-X series, to view surface height appearances. Preferably, the surface roughness measurement is performed according to ISO 25178. In general, the main influence on the surface roughness is the pixel size. Thus, in general in well balanced systems, the pixel size substantially equals the roughness depth Rz of the manufactured physical object, e.g. a pixel size of 30 μm generally leads to a surface roughness depth Rz of the manufactured physical object of approximately 30 μm. However, the effective surface roughness can also be dependent on further factors, such as the measurement direction of the physical object, the topology of the part, e.g. flat vs. curved surfaces, light scattering, light exposure time, quality of the optics, post-processing and the properties of the hardenable material.

In particular, the surface quality can be determined based on the fidelity of the surface quality of the manufactured physical object in comparison with a digital representation of the physical object, such as in a CAD model of the object to be manufactured. The digital representation of the physical object can thus be viewed as having the highest theoretically achievable surface quality.

Hence, a smaller desired fidelity, i.e. a larger deviation between the theoretically achievable surface quality and the desired practical surface quality of the physical object, can allow a lower surface quality of the manufactured physical object with larger steps on the surface of the manufactured physical object. A higher fidelity can thus require a more precise surface quality of the manufactured physical object with smaller steps on the surface of the manufactured physical object.

For this purpose, the surface of the manufactured physical object can be detected during the manufacturing process or in between manufacturing processes, for instance by means of a surface quality detecting device, such as a tactile measuring device for measuring surface roughness or a computed tomography (CT), which can determine the achieved surface quality of the physical object. The 3D printing system can then detect deviations between the achieved surface quality and the desired surface quality. The 3D printing system can thereupon adjust the manufacturing settings, such as displacement step size or optical resolution, without intervention by the user, for instance by selecting a different optical resolution during a manufacturing process or in between manufacturing processes. The 3D printing system can optionally prompt the user to confirm the suggested adjustment of the settings before storing the adjusted settings. Thus, the manufacturing settings used to achieve different surface qualities can be documented and used to control and/or verify the quality of the 3D printing system.

Preferably, selecting at least one or at least two optical resolutions from two or more optical resolutions available in the 3D printing system for irradiating the hardenable material according to the method disclosed herein can be performed once for a manufacturing process of at least one physical object. Alternatively, selecting at least one or at least two optical resolutions from two or more optical resolutions available in the 3D printing system for irradiating the hardenable material according to the method disclosed herein can be performed multiple times during a single manufacturing process of at least one physical object.

The method can be used for a wide variety of physical objects. In particular, the method can be employed for medical products, such as dental restorations. Thus, the method can be used, for example, to manufacture dental crowns and/or bridges. According to the method disclosed herein, the method can be quickly adapted to the different surface quality requirements between different products manufactured in the same production. This allows, for instance, the same 3D printing system to be used for the manufacturing of a wide range of different physical products having different surface quality requirements. Furthermore, a single physical object can be manufactured with different surface qualities in different sections of the physical object. For instance, a crown can be manufactured having a rougher surface on its inner side compared to the outer sides. Thus, for instance, the adhesion of dental cement on the inner side can be enhanced by providing a rougher surface on the inner side while achieving a smoother surface quality on the outer sides. Further physical objects which can be manufactured by the method include splints, surgical guides and/or dental night guards.

According to the method disclosed herein, a layer of the hardenable material is selectively hardened by irradiating light having the at least one or at least two selected optical resolutions provided by at least one light engine provided within the 3D printing system. This means that the optical resolution can be varied while using only one light engine.

Alternatively, however, the 3D printing system can include two or more light engines. The optical resolution can be selected by altering the optical resolution of at least one of the available plurality of light engines. However, the optical resolution can be varied by switching from one light engine having a certain optical resolution to another light engine having a different optical resolution during a manufacturing process of a physical object or in between manufacturing processes of different physical objects.

According to the method, the layer of hardened material can be displaced relative to the focal plane of the irradiated light. This can be achieved by means of a displacing device which can displace the physical object and thus the layer of hardened material as an absolute movement. The physical object can be attached to a build platform which can be displaceable by means of the displacing device. Thus, the entire physical object, including the hardened layer, can be displaced relative to the focal plane of the irradiated light. The layer of hardened material can preferably be displaced away from the light engine.

The layer of hardened material can preferably be displaced step-wise, i.e. discontinuously, preferably away from the light engine. The layer of hardened material can preferably be displaced by a step size, wherein the step size can be constant during the manufacturing process of the physical object. However, the step size can also be variable within the manufacturing process of the physical object. The layer of hardened material can alternatively be displaced continuously at a set or variable speed during the manufacturing process of the physical object.

The step-size can preferably be in a range from 10 μm to 100 μm, preferably from 20 μm to 80 μm, more preferably from 30 to 70 μm.

In the case of continuous displacement, the layer of hardened material can be displaced at a speed ranging from 0.01 mm/s to 20 mm/s, preferably from 0.1 mm/s to 15 mm/s, more preferably from 0.3 mm/s to 10 mm/s, more preferably from 0.5 to 5 mm/s, most preferably from 0.6 to 2 mm/s.

According to the method disclosed herein, a single physical object or two or more physical objects can be manufactured simultaneously. Alternatively, two or more physical objects can be manufactured semi-simultaneously, meaning two or more physical objects are manufactured in one manufacturing process within a single 3D printing system but the manufacturing steps are conducted at least during a portion of the manufacturing process time-shifted for each physical object.

Preferably, two different physical objects, each having a different surface quality and thus manufactured with different optical resolutions, can be manufactured. Thus, for instance, a smaller part using a higher optical resolution and a larger part using a lower optical resolution can be manufactured simultaneously.

In the context of the present disclosure, the light engine preferably comprises at least one light module, such as a laser or projector. The light engine can further comprise at least one optics for focusing the light onto the focal plane. The light engine can be a non-modular member, meaning the at least one light source and the at least one optics are not interchangeable, or are at least not intended to be interchangeable, for the specific light engine. Thus, the optical resolution within the method disclosed herein can be selected, and thus can be adjusted, by selecting a light engine, including its at least one light module and its at least one optics, from a plurality of light engines, each having their own at least one light module and at least one optics. In addition to the light engine, an additional laser or a plurality of lasers can be provided to emit a laser beam onto the physical object and thereby smooth the physical object, preferably along the boundaries of the physical object. The additional laser can be used simultaneously, sequentially or in an alternating fashion with the light engine.

However, the light engine can alternatively be of a modular configuration, meaning the at least one light source and the at least one optics can be interchanged in the light engine during and/or between manufacturing processes to change the optical resolution of the irradiated light.

Thus, preferably the optical resolution can be selected by selecting at least one light engine from a plurality of light engines provided in the 3D printing system, each light engine having a different set optical resolution.

A set optical resolution thereby refers to an optical resolution of a light engine which cannot be adjusted, for instance by interchanging the optics and/or the light module, such as a different projector.

In this case, the 3D printing system can comprise a plurality of light engines, meaning two or more light engines. Since each light engine has a different set optical resolution, a single 3D printing system having a plurality of light engines, each light engine having a different set optical resolution, can provide a range of achievable optical resolutions, and thus a range of achievable surface qualities of physical objects to be manufactured.

This also allows conventional 3D printing devices to be adapted to the method disclosed herein in a simple manner, i.e. by installing a plurality of light engines, each having a different optical resolution, in the existing 3D printing device.

Alternatively, the optical resolution can be selected by selecting an optics, from a plurality of optics for use with a single light engine of the at least one light engine, wherein each optics has a different set focal length.

In this case, at least one light engine is provided with a modular configuration, meaning the optics of at least one light engine is interchangeable to select and vary between a plurality of achievable optical resolutions during a manufacturing process or in between manufacturing processes.

The optics can be interchanged by displacing the optics by means of a displacing device. The displacing device can be a rotating device carrying a plurality of different optics. By rotating the rotating device the desired optics can be aligned with the light irradiated from the light source while the previously used optics is moved out of the irradiated light, thereby interchanging the desired optics. Alternatively, the displacing device can displace the optics translationally.

However, the optical resolution can also be selected by selecting a zoom setting of a zoomable optics of the at least one light engine, wherein different zoom settings provide different focal lengths.

By selecting and adjusting a zoom setting of a zoomable optics, the optical resolution of the light engine can be selected and adjusted in a stepless manner. This allows the optical resolution of a single light engine to be flexibly adjusted according to the required surface quality of the physical object to be manufactured.

A plurality of light engines each having a zoomable optics, preferably with different zoom ranges, can also be provided and selected. Alternatively, not all of the plurality of light engines can have a zoomable optics. In this case, some of the selectable plurality of light engines, i.e. one or more light engines, can have a zoomable optics while the other available light engines can have a fixed optics with a set focal length or an interchangeable optics, as described above.

Preferably, at least two physical objects having different predetermined surface qualities are manufactured by the 3D printing system simultaneously, each by means of at least one separate light engine of at least two light engines provided within the 3D printing system. The at least two light engines can preferably have different selected optical resolutions. Preferably, a higher optical resolution is selected for the physical object to be manufactured having a higher predetermined surface quality.

This allows for quick and efficient manufacturing of several physical objects. Furthermore, this allows for physical objects having different predetermined surface qualities to be manufactured simultaneously in a single 3D printing system.

Preferably, at least one physical object is manufactured in the printing system by means of at least two light engines having different selected optical resolutions. The at least one physical object is preferably manufactured simultaneously by the at least two light engines.

In this case, a physical object can be manufactured with different surface qualities. For instance, the physical object can have a higher surface quality in at least one section thereof, while at least a different section of the physical object can have a lower surface quality. Thus, a physical object having a non-uniform surface quality can be manufactured.

This enables the physical object to be optimally manufactured based on the required surface quality in various sections of the physical object. Thus, the physical object can be manufactured according to its surface quality requirements under optimal time conditions instead of manufacturing the physical object uniformly with the highest required surface quality.

For instance, a base form of a physical object, such as a dental restoration, e.g. a dental crown, can be manufactured with a first optical resolution to achieve a first surface quality using a first hardenable material. Thereupon, a top coating layer or multiple top coating layers can be hardened onto the base form using a second optical resolution to achieve a second surface quality, the second optical resolution and the second surface quality being preferably higher than the first optical resolution and the first surface quality, preferably using a second hardenable material. The first and second hardenable materials can also be the same material and/or have the same qualities. Thus, a physical object having an outer coating with a higher surface quality than the base form can advantageously be manufactured.

Preferably, the layer of hardened material can be displaced relative to the focal plane of the irradiated light discontinuously by displacing the layer of hardened material by a step size.

The physical object, and thus the layer of hardened material, can be displaced by moving the entire physical object by means of a displacing device. In this case, the physical object can preferably be attached to a build platform, which in turn can be displaced by the displacing device.

The step size, often referred to as a z-step size due to the z-axis of the 3D printing device commonly extending in the direction of this displacement, can be constant during the manufacturing process of the physical object. However, the step size can alternatively be varied during the manufacturing process of the physical object, for instance in order to harden layers of hardenable material of different thicknesses during the manufacturing process of the physical object. In this case, the energy dose of the light to the hardenable material can be adjusted based on the layer thickness by adjusting the specific power of the light source in W/m² and/or by adjusting the exposure time of the light on the hardenable material. By increasing the specific power of the light source and/or the exposure time of the light on the hardenable material, the energy dose can be increased. Vice versa, by decreasing the specific power of the light source and/or the exposure time of the light on the hardenable material, the energy dose can be decreased. Thus, for instance, the energy dose can be increased, thereby increasing the curing depth of the irradiated light, when using larger step sizes and thus when hardening thicker layers of hardenable material. Vice versa, the energy dose can be decreased, thereby decreasing the curing depth of the irradiated light, when using smaller step sizes and thus when hardening thinner layers of hardenable material.

The step size can preferably be in a range from 1 μm to 150 μm, preferably from 20 μm to 80 μm, more preferably from 25 to 70 μm.

The step size can be predetermined or determined during the manufacturing process, for instance by a controller. For instance, the controller can thereby react to any deviations in the achieved surface quality of the physical object as it is being manufactured in comparison to a desired surface quality. For this purpose, the physical object can be scanned by a scanning device, such as an optical scanning device or a tactile measuring device for measuring the surface roughness of the physical objects, which can determine the actually achieved surface quality of the physical object. The controller and/or the scanning device can determine deviations between the actually achieved surface quality of the physical object and a desired achieved surface quality of the physical object. Based on any determined deviations, the controller can adjust the step size accordingly.

Preferably, the layer of hardened material can be displaced relative to the focal plane of the irradiated light continuously and concurrently with step c) by displacing the layer of hardened material at a set or variable displacement speed. Preferably, for higher displacement speeds the energy dose of the light emitted onto the hardenable material can be adjusted by adjusting the specific power of the light source in W/m² and/or by adjusting the exposure time of the light on the hardenable material. By increasing the specific power of the light source and/or the exposure time of the light on the hardenable material, the energy dose can be increased. Vice versa, by decreasing the specific power of the light source and/or the exposure time of the light on the hardenable material, the energy dose can be decreased. Thus, for instance, the energy dose can be increased when using higher displacement speeds. Vice versa, the energy dose can be decreased when using lower displacement speeds.

Preferably, for each of the at least two physical objects to be manufactured the layer of hardened material can be displaced relative to the focal plane of the irradiated light separately.

This enables a flexible method of manufacturing at least two physical objects at least partially independent from one another. Thus, at least one physical object of the at least two physical objects can be displaced at a different speed or a different step size than a further physical object of the at least two physical objects.

Alternatively, the layers of hardened material of the at least two physical objects to be manufactured can be displaced synchronously.

Preferably, steps c) and d), and optionally step b), can be repeated multiple times. Preferably, the light can be irradiated onto a focal plane within the hardenable material of each of the at least two physical objects at different displacement intervals.

The physical objects can thereby be manufactured according to their individual requirements.

Preferably, the method, after step d), can further include the step of:
e) cleaning the physical object from excess material by moving the physical object and thereby generating a mass inertial force in the excess material.

Typically some of the hardenable material resides on the outer surface of the object as excess material after building up the physical object. This excess material is generally undesired because it forms an additional structure on the actual shape of the physical object and can contain undesired monomers and/or may not form a durable structure.

The advantage of cleaning the physical object from excess material by moving the physical object and thereby generating a mass inertial force in the excess material is that it allows for extensively cleaning objects that are built up by additive manufacturing from undesired adherent excess material. In particular the cleaning of the objects is non-invasive and contact-free. Therefore, the physical object is prevented from structural damages or mechanical failures. Alternatively or additionally, the physical object can be cleaned from excess material by applying a material removing medium to the physical object, such as a solvent and/or and air jet and/or an abrasive material.

The term “mass inertial force” as referred to herein may be specified as force per unit mass and therefore may be specified in the unit m/s² Furthermore, the mass inertial force can be expressed by the G-force which is a factor of the acceleration of gravity. For the purpose of the present disclosure the acceleration of gravity is 9.81 m/s². Consequently, for example a mass inertial force of 9.81 m/s² can be expressed as 1 G.

Thus, at least some of the adhering hardenable material is preferably caused to separate from the physical object in consequence of an acceleration force or mass inertial force acting on the adherent excess material. The acceleration force or mass inertial force is induced by moving, for example rotating, the physical object. The wording “caused to separate from the object” is to be understood in that portions of the adhering hardenable material separate out of the film that covers the outer surface of the physical object. Thus, this can reduce the extent of any further cleaning of the physical object of excess material or eliminate any further cleaning of the physical object of excess material altogether.

Preferably, the amount of mass inertial force generated can be selected based on the predetermined surface quality of each physical object to be manufactured.

The mass inertial force generated is dependent on the radius of the physical object in meters and the rotational speed of the physical object in rotations per second. Thus, the higher the rotational speed the larger the mass inertial force generated for a certain radius of the physical object. Thus, increasing the rotational speed can result in more material being removed from the physical object. However, this can result in rougher outer surfaces of the physical object. Selecting a rotational speed which is too low can result in not enough excess material being removed from the physical object, which can lead to dimensions of the physical object which are outside of required tolerances.

Therefore, the predetermined surface quality can be selected based on the predetermined surface quality of each physical object to be manufactured.

Preferably, the rotational speed can be selected from 3 rotations per second to 100 rotations per second, preferably from 10 rotations per second to 80 rotations per second, more preferably from 20 rotations per second to 60 rotations per second, most preferably from 30 rotations per second to 50 rotations per second.

The mass inertial force can preferably be selected to be generated for a variable amount of time, preferably for at least 15 seconds, more preferably at least 30, more preferably at least 60 seconds, more preferably at least 90 seconds, more preferably at least 120 seconds, more preferably at least 180 second, most preferably at least 200 seconds.

The concept of cleaning the physical object from excess material by moving the physical object and thereby generating a mass inertial force in the excess material is disclosed in WO 2019/023120 A1, the content of which is hereby incorporated by reference.

It is also an object of the invention to provide a 3D printing system which allows more efficient and flexible manufacturing of a physical object.

This object is achieved by a 3D printing system for manufacturing at least one physical object. The advantages and features described in relation to the method apply accordingly to the 3D printing system described below.

The 3D printing system comprises at least one reservoir for receiving hardenable material. The reservoir, often referred to as a vat, can preferably be substantially rectangular in shape and can preferably have a base and four side walls defining a volume for receiving the hardenable material.

The size of the reservoir is determined mainly by the size of the physical object to be manufactured. Thus, the reservoir can be releasably attached to the 3D printing system to allow quick interchanging of the reservoir in exchange for a reservoir having a different size to accommodate differently sized physical objects to be manufactured. Preferably, the reservoir can be slidably attached to the 3D system.

The 3D printing system further comprises at least one light engine configured to irradiate light onto a focal plane within the reservoir of the hardenable material to form a layer of hardened material.

As described in relation to the method disclosed herein, the light engine preferably comprises at least one light module, such as a laser or a projector. The light engine further preferably comprises at least one optics for focusing the light onto the focal plane. The light engine can be a non-modular member, meaning the least one light source and the at least one optics are non-interchangeable or are at least not intended to be interchangeable.

The 3D printing system further comprises at least one build platform for carrying the physical object to be manufactured. The physical object can preferably be attached to the build platform by hardening the first layer of the physical object directly onto a surface of the build platform. Alternatively, a preform of the physical object can be attached to the build platform by means of a securing means, such as via a tongue and groove, and the layers of hardenable material can be hardened onto the preform.

The 3D printing system further comprises a controller configured to select at least one or at least two optical resolutions from two or more optical resolutions available in the 3D printing system for irradiating the hardenable material based on a predetermined surface quality of the physical object to be manufactured. Thus, the optical resolution can be selected, and thus changed by the controller, for example, by selecting a light engine, including its at least one light module and its at least one optics, from a plurality of light engines, each having their own at least one light module and at least one optics.

The controller can preferably be configured to select at least one or at least two optical resolutions from two or more optical resolutions available in the 3D printing system based on an input by the user. For instance, the user can input a predetermined surface quality for a physical object to be manufactured into an input device comprised by the 3D printing system, based on which the controller selects the appropriate optical resolution to achieve the predetermined surface quality. However, the controller can also autonomously select the optical resolution, for example based on a detection of the physical object to be manufactured and its corresponding required surface quality by the 3D printing system, for instance by means of an optical scanning device.

Preferably, the 3D printing system can comprise at least one displacing unit for displacing the at least one reservoir and/or the at least one build platform.

When displacing the reservoir as an absolute movement, the hardenable material in the reservoir is displaced relative to the physical object. This allows the hardenable material to collect underneath the layer of material hardened in the last hardening step. Thus, the hardening step can be repeated.

However, preferably, the at least one build platform is displaced relative to the reservoir. In this case, the physical object is displaced as an absolute movement, preferably away from the light engine.

Alternatively, a combination of an absolute displacement of the at least one reservoir and the at least one build platform can be realized, wherein the at least one reservoir and the at least one build platform can preferably be displaced by a single displacing unit. Alternatively, however, the at least one reservoir and the at least one build platform can be displaced by separate displacing units independent from each other.

Preferably, the 3D printing system can comprise at least two reservoirs and/or at least two build platforms for manufacturing at least two physical objects.

The at least two reservoirs and/or at least two build platforms are advantageous for manufacturing a plurality of physical objects. This allows, for instance, for physical objects having different sizes and/or requiring different hardenable materials to be manufactured in a single 3D printing system by providing a plurality of different hardenable materials in the at least two reservoirs. The at least two reservoirs can also be of different shapes and sizes, for instance to accommodate physical objects of different shapes and sizes to be manufactured. For instance, two different hardenable materials can be provided, one in each of the reservoirs. Preferably, at least two physical objects can be manufactured simultaneously. Alternatively, the at least two physical objects can be manufactured sequentially.

Preferably, the 3D printing system can comprise at least two displacing units for displacing the at least two reservoirs and/or the at least two build platforms individually. At least two physical objects can thereby be manufactured independent from one another by displacing each physical object individually according to its surface quality requirements. This allows, for instance, for one physical object to be displaced at different speeds or step sizes than a different physical object.

Preferably, the 3D printing system can comprise a centrifuge having a rotor configured to receive the manufactured physical object and to generate a mass inertial force in the excess material of the physical object, thereby cleaning the physical object from excess material.

Preferably, the 3D printing system can comprise at least two light engines each having different set optical resolutions.

Preferably, the 3D printing system can comprise at least one light engine having a zoomable optics.

Preferably, the 3D printing system can comprise at least two optics each having different focal lengths configured to be used with a single light engine within the 3D printing system.

Preferably, the 3D printing system can comprise a memory configured to store settings of predetermined desired surface qualities of physical objects to be manufactured. The controller can preferably communicate with the memory to select the at least one optical resolution, preferably based on the settings selected from the memory.

This allows for the 3D printing system to quickly access manufacturing settings for a particular physical object to be manufactured. The manufacturing settings can be stored in the memory manually via input by the user. However, the 3D printing system can also adapt the settings autonomously, for instance via a stored algorithm, based on the achieved manufacturing settings of manufactured physical objects. The 3D system can comprise a surface quality detection device, such as a visual scanning device or a tactile measuring device for measuring surface roughness, which can determine the achieved surface quality. The 3D printing system can then detect deviations between the achieved surface quality and the desired surface quality. The 3D printing system can thereupon adjust the stored manufacturing settings, such as displacement step size or optical resolution, without intervention by the user. The 3D printing system can prompt the user to confirm the suggested adjustment of the settings before storing the adjusted settings.

Further advantages, features and details of the invention are disclosed in the following description of preferred embodiments based on the drawings. The features and combinations of features as described in the above as well the features and combinations of features described in the following are not to be considered as being disclosed only in the described combinations but rather in other combinations and/or the features by themselves without leaving the scope of the invention.

The following list of aspects provides alternative and/further features of the invention:
1. A method of manufacturing at least one physical object by means of a single 3D printing system, the method comprising the steps of:
   a) providing at least one hardenable material, preferably a paste and/or a liquid;
   b) selecting at least one or at least two optical resolutions from two or more optical resolutions available in the 3D printing system for irradiating the hardenable material;
   c) selectively hardening a layer of the hardenable material by irradiating light having the at least one or at least two selected optical resolutions provided by at least one light engine provided within the 3D printing system onto a focal plane within the hardenable material to form a layer of hardened material; and
   d) displacing the layer of hardened material, preferably relative to the focal plane of the irradiated light;
wherein preferably selecting the at least one or at least two optical resolutions is based on a predetermined surface quality of the at least one physical object to be manufactured.
2. The method according to aspect 1, wherein the optical resolution is selected by selecting at least one light engine from a plurality of light engines provided in the 3D printing system, each light engine having a different set optical resolution.
3. The method according to aspect 1, wherein the optical resolution is selected by selecting an optics, from a plurality of optics for use with preferably a single light engine of the at least one light engine, wherein each optics has a different set focal length.
4. The method according to aspect 1, wherein the optical resolution is selected by selecting a zoom setting of a zoomable optics of the at least one light engine, wherein different zoom settings provide different focal lengths.
5. The method according to any one of the preceding aspects, wherein at least two physical objects having different predetermined surface qualities are manufactured by the 3D printing system simultaneously, each by means of at least one separate light engine of at least two light engines provided within the 3D printing system, wherein the at least two light engines have different selected optical resolutions, wherein preferably a higher optical resolution is selected for the physical object to be manufactured having a higher predetermined surface quality.
6. The method according to any one of aspects 1 to 5, wherein at least one physical object is manufactured in the printing system by means of at least two light engines having different selected optical resolutions, wherein preferably the at least one physical object is manufactured simultaneously by the at least two light engines.
7. The method according to any one of the preceding aspects, wherein the layer of hardened material is displaced relative to the focal plane of the irradiated light discontinuously by displacing the layer of hardened material by a variable or constant step size during the manufacturing process.
8. The method according to any one of aspects 1 to 6, wherein the layer of hardened material is displaced relative to the focal plane of the irradiated light continuously and concurrently with step c) by displacing the layer of hardened material at a set or variable displacement speed.
9. The method according to any one of aspects 5 to 8, wherein for each of the at least two physical objects to be manufactured the layer of hardened material is displaced relative to the focal plane of the irradiated light separately.
10. The method according to any one of aspects 5 to 8, wherein the layers of hardened material of the at least two physical objects to be manufactured are displaced synchronously.
11. The method according to any one of aspects 7 to 10, wherein at least steps c) and d), and optionally also step b) and/or step a), are repeated multiple times and wherein light is irradiated onto a focal plane within the hardenable material of each of the at least two physical objects at different displacement intervals.
12. The method according to any one of the preceding aspects, wherein the method, after step d), further includes the step of:
   e) cleaning the physical object from excess material by moving the physical object and thereby generating a mass inertial force in the excess material.
13. The method according to aspect 12, wherein the amount of mass inertial force generated is selected based on the predetermined surface quality of each physical object to be manufactured.
14. A 3D printing system for manufacturing at least one physical object, comprising:
   at least one reservoir for receiving hardenable material;
   at least one light engine configured to irradiate light onto a focal plane within the reservoir of the hardenable material to form a layer of hardened material;
   at least one build platform for carrying the physical object to be manufactured;
   a controller configured to select at least one or at least two optical resolutions from two or more optical resolutions available in the 3D printing system for irradiating the hardenable material based on a predetermined surface quality of the physical object to be manufactured.
15. The 3D printing system according to aspect 14, comprising at least one displacing unit for displacing the at least one reservoir and/or the at least one build platform.
16. The 3D printing system according to any one of aspects 14 and 15, wherein the 3D printing system comprises at least two reservoirs and/or at least two build platforms for manufacturing at least two physical objects.
17. The 3D printing system according to aspect 16, wherein the 3D printing system comprises at least two displacing units for displacing the at least two reservoirs and/or the at least two build platforms individually.
18. The 3D printing system according to any one of aspects 14 to 17, further comprising a centrifuge having a rotor configured to receive the manufactured physical object and to generate a mass inertial force in the excess material of the physical object, thereby cleaning the physical object from excess material.
19. The 3D printing system according to any one of aspects 14 to 18, wherein the 3D printing system comprises at least two light engines each having different set optical resolutions.
20. The 3D printing system according to any one of aspects 14 to 19, wherein the 3D printing system comprises at least one light engine having a zoomable optics.
21. The 3D printing system according to any one of aspects 14 to 20, wherein the 3D printing system comprises at least two optics each having different focal lengths configured to be used with a single light engine within the 3D printing system.
22. The 3D printing system according to any one of aspects 14 to 21, further comprising a memory configured to store settings of predetermined desired surface qualities of physical objects to be manufactured, wherein the controller can communicate with the memory to select the at least one optical resolution based on the settings selected from the memory.

Preferred embodiments of the present invention are further elucidated below with reference to the figures.

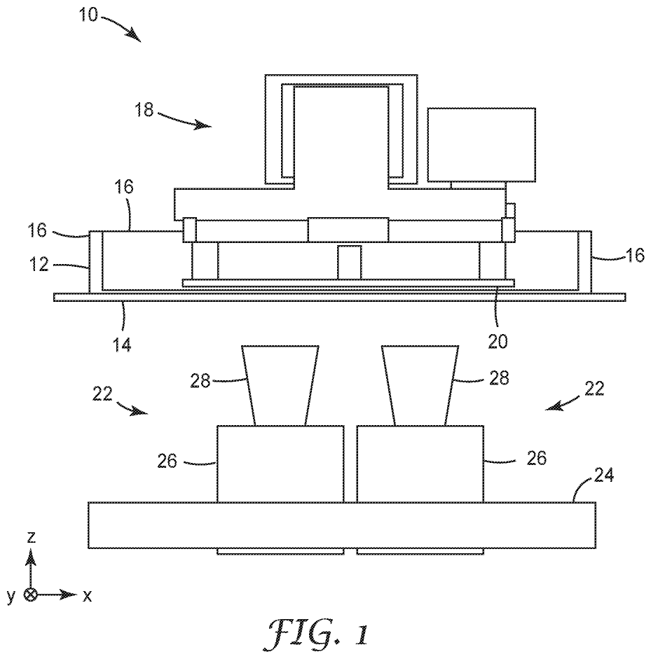

FIG. 1 shows a sectional view of an embodiment according to the invention;

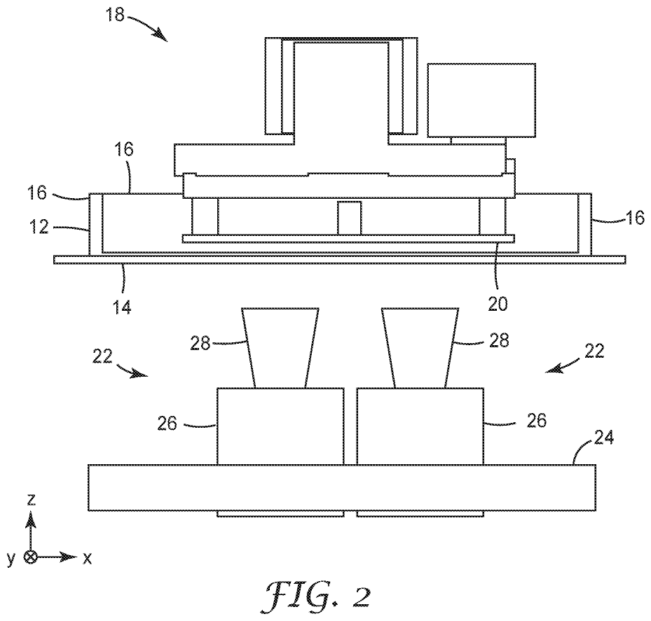

FIG. 2 shows a sectional view of the embodiment shown in FIG. 1; and

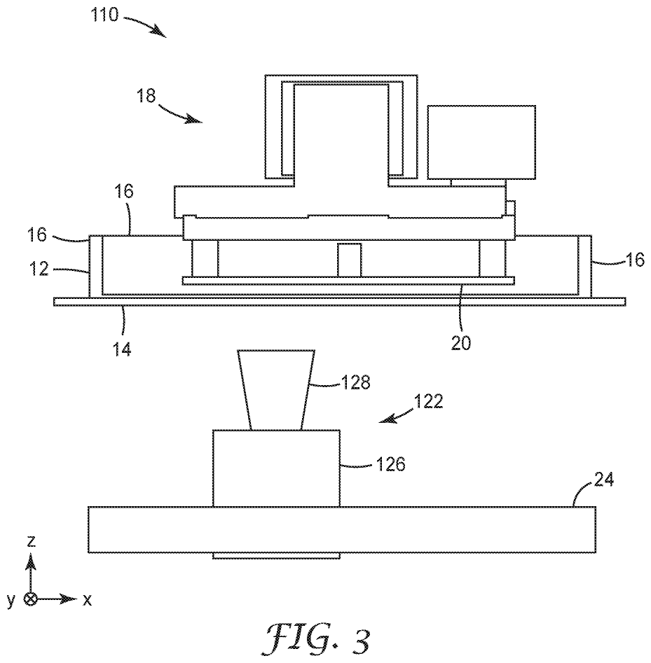

FIG. 3 shows a sectional view of a further embodiment according to the invention.

FIG. 1 shows a 3D printing system 10 comprising a reservoir 12 for receiving a hardenable material, such as a liquid and/or a paste. The reservoir 12 comprises a transparent base 14 and four side walls 16, of which only three are visible in FIG. 1 due to the sectional view of the 3D printing system 10 shown in FIG. 1. The transparent base 14 and the four side walls 16 define a volume for receiving the hardenable material (not shown).

The 3D printing system 10 further comprises a build platform 18 which can preferably be displaceable by means of a displacing device (not shown). The build platform 18 comprises a build plate 20 onto which the layers of hardenable material are hardened to form the physical object to be manufactured (not shown).

The 3D printing system 10 also comprises two light engines 22 arranged under the built platform 18, which are connected to a single carrier unit 24. Each light engine 22 comprises a light module 26 for generating light which can be irradiated from the light engines 22. The light modules 26 are only shown schematically in FIG. 1 without further detail. The light modules 26 can, for example, be a laser or a light projector.

Each light engine 22 further comprises an optics 28. One or both of the optics 28 can have a set focal length. Hence, the optical resolution of the 3D printing system 10 can be selected and optionally adjusted by selecting at least one of the two light engines 22 available within the 3D printing system 10. Preferably, a plurality of physical objects can be manufactured, each by a different light engine 22 having a different selected optical resolution. The plurality of physical objects can preferably be manufactured simultaneously.

Alternatively, at least one of the optics 28 can be a zoomable optics having different zoom settings, each zoom setting preferably providing a different focal length for the irradiated light.

At least one of the light engines 22 can also have a modular configuration, meaning the optics 28 of at least one of the light engines 22 can be interchanged in order to pair at least one of the light modules 26 with different optics 28, preferably having different focal lengths.

Alternatively, the light module 26 of at least one of the light engines 22 can be interchangeable in order to pair different light modules 26 with one or more optics 28.

FIG. 1 also shows an xyz coordinate system of the 3D printing system 10. The x-axis and the y-axis extend substantially parallel to the build plate 20, wherein the y-axis extends into the drawing plane and the x-axis extends perpendicular to the y-axis. The z-axis extends substantially perpendicular to the build plate 20.

When manufacturing a physical object with the 3D printing system 19, a hardenable material can first be provided in the reservoir 12.

Subsequently or prior to providing the hardenable material in the reservoir 12, a controller (not shown) of the 3D printing system 10 can select at least one or at least two optical resolutions from two or more optical resolutions available in the 3D printing system 10 for irradiating the hardenable material received in the reservoir 12. The two or more light resolutions available in the 3D printing system 10 can be realized by the two light engines 22, for example by each light engine 22 having an optics 28 with a different focal length and/or by each light module 26 having a different optical resolution.

Additionally or alternatively, at least one of the light engines 22 can have a modular configuration. In this case, the 3D printing system 10 can comprise a plurality of interchangeable optics 28, each having a different focal length, to be paired with at least one of the light modules 26.

Alternatively, at least one of the light engines 22 can comprise a zoomable optics 28 having different zoom settings, wherein different zoom settings provide different focal lengths in order to adjust the optical resolution of the light irradiated by at least one of the light engines 22.

Light having the at least one selected optical resolution is irradiated from at least one of the light engines 22 onto a focal plane within the hardenable material received in the reservoir 12.

Thereby, at least a portion of the hardenable material is hardened onto the build plate 20 or onto a preform attached to the build plate 20 as a layer of hardened material to form at least a portion of the physical object to be manufactured.

Thereupon, the layer of hardened material is displaced in the z-direction relative to the focal plane by displacing the build platform 18, and thus the build plate 20, by means of a displacing device. Moreover, the reservoir 12 can additionally or alternatively be displaced by means of a displacing device (not shown).

Alternatively, the 3D printing system 10 can comprise a plurality of build platforms 18 and/or a plurality of build plates 20. This is particularly advantageous to manufacture a plurality of physical objects, with at least one physical object being manufactured on each build plate 20. Preferably, the plurality of physical objects to be manufactured can be different physical objects having different desired properties, such as different shapes and/or sizes and/or different desired surface qualities. In this case, each build platform 18 and/or each build plate 20 can be displaceable by means of a single displacing device or each by its own displacing device.

Alternatively, the 3D printing system 10 can also comprise a plurality of reservoirs 12, preferably to receive different hardenable materials, such as hardenable materials having different properties, such as different viscosities and/or different densities and/or different porosities. The plurality of reservoirs 12 can each have a different shape and/or size.

FIG. 2 shows substantially the same configuration of the 3D printing system 10 of FIG. 1. In contrast to FIG. 1, the build platform 18, and thus the build plate 20, in FIG. 2 has been displaced in comparison to the configuration shown in FIG. 1 in the positive z-direction. This simulates the displacement of the build platform 18, and thus of the build plate 20, in order to displace the physical object after a bottom layer of hardenable material has been hardened on the physical object. The build platform 18 can be displaced continuously at a constant or varying speed. Alternatively, the build platform 18 can be displaced step-wise by a constant or varying step size during the manufacturing process.

After displacing the build platform 18, preferably at least one further layer of hardenable material is hardened onto the physical object. Optionally, before the at least one further layer of hardenable material is hardened onto the physical object, the desired or required optical resolution of the light irradiated to harden the hardenable material can be reassessed and can be reselected, to optionally adjust the optical resolution or maintain the optical resolution selected previously.

For this purpose, the 3D printing system 10 can comprise a surface quality detecting device, such as a tactile measuring instrument, to assess the achieved surface quality. For example, if the assessed surface quality is not within tolerances of the desired surface quality of the physical object, the controller can reselect an optical resolution according to the desired or predetermined surface quality of the physical object.

FIG. 3 shows a configuration of a 3D printing system 110 according to another embodiment. The 3D printing system comprises substantially the same features as the 3D printing system 10 shown in FIGS. 1 and 2. The parts which are identical in all figures are correspondingly marked with the same reference signs.

In contrast to the 3D printing system 10 shown in FIGS. 1 and 2, the 3D printing system 110 shown in FIG. 3 comprises only a single light engine 122 comprising a light module 126 and an optics 128. The light engine 122 is connected to a carrier unit 24.

Thus, the optical resolution of the 3D printing system 110 can be selected and adjusted, for instance, by interchanging the optics 128 and/or the light module 126 of the light engine 122. Hence, the 3D printing system 110 can provide a plurality of optics 128 (not shown), each having a different set focal length, in order to select and adjust the optical resolution of the 3D printing system 110 to achieve different surface qualities of the physical object to be manufactured by a single 3D printing system 110. Additionally, or alternatively, the optics 128 can be a zoomable optics having different zoom settings providing different focal lengths in order to adjust the optical resolution of the irradiated light. Thus, by selecting a zoom setting of the zoomable optics 128, a light resolution of the light irradiated by the light engine 122 can be selected and preferably be adjusted.

Thus, a plurality of light modules 126 (not shown) can alternatively or additionally be provided in the 3D printing system 110, each having a different optical resolution, in order to select an optical resolution from a plurality of optical resolutions available within the 3D printing system 110 by selecting at least one of the available plurality of light modules 126 within the 3D printing system 110.

1. A method of manufacturing at least one physical object by means of a single 3D printing system, the method comprising the steps of:
a) providing at least one hardenable material;
b) selecting at least two optical resolutions from two or more optical resolutions available in the 3D printing system for irradiating the hardenable material;
c) selectively hardening a layer of the hardenable material by irradiating light having the at least two selected optical resolutions provided by at least two light engines provided within the 3D printing system onto a focal plane within the hardenable material to form a layer of hardened material; and
d) displacing the layer of hardened material relative to the focal plane of the irradiated light;
wherein selecting the at least two optical resolutions is based on a predetermined surface quality of the at least one physical object to be manufactured.

2. The method according to claim 1, wherein the optical resolution is selected by selecting at least one light engine from a plurality of light engines provided in the 3D printing system, each light engine having a different set optical resolution.

3. (canceled)

4. The method according to claim 1, wherein the optical resolution is selected by selecting a zoom setting of a zoomable optics of at least one light engine, wherein different zoom settings provide different focal lengths.

5. The method according to claim 1, wherein at least two physical objects having different predetermined surface qualities are manufactured by the 3D printing system simultaneously, each by means of at least one separate light engine of at least two light engines provided within the 3D printing system, wherein the at least two light engines have different selected optical resolutions, wherein a higher optical resolution is selected for the physical object to be manufactured having a higher predetermined surface quality.

6. The method according to claim 1, wherein at least one physical object is manufactured in the 3D printing system by means of the at least two light engines having different selected optical resolutions, wherein preferably the at least one physical object is manufactured simultaneously by the at least two light engines.

7. The method according to claim 1, wherein the layer of hardened material is displaced relative to the focal plane of the irradiated light discontinuously by displacing the layer of hardened material by a step size.

8. The method according to claim 1, wherein the layer of hardened material is displaced relative to the focal plane of the irradiated light continuously and concurrently with step c) by displacing the layer of hardened material at a set or variable displacement speed.

9. The method according to claim 5, wherein the layers of hardened material of the at least two physical objects to be manufactured are displaced synchronously.

10. A 3D printing system for manufacturing at least one physical object, comprising:
at least one reservoir for receiving hardenable material;
at least two light engines configured to irradiate light onto a focal plane within the reservoir of the hardenable material to form a layer of hardened material;
at least one build platform for carrying the physical object to be manufactured;
a controller configured to select at least two optical resolutions from two or more optical resolutions available in the 3D printing system for irradiating the hardenable material based on a predetermined surface quality of the physical object to be manufactured.

11. The 3D printing system according to claim 10, comprising at least one displacing unit for displacing the at least one reservoir and/or the at least one build platform.

12. The 3D printing system according to claim 10, wherein the 3D printing system comprises at least two reservoirs and/or at least two build platforms for manufacturing at least two physical objects.

13. The 3D printing system according to claim 10, wherein the 3D printing system comprises at least two displacing units for displacing the at least two reservoirs and/or the at least two build platforms individually.

14. The 3D printing system according to claim 10, wherein the 3D printing system comprises at least two light engines each having different set optical resolutions.

15. The 3D printing system according to claim 10, further comprising a memory configured to store settings of predetermined desired surface qualities of physical objects to be manufactured, wherein the controller can communicate with the memory to select the at least one optical resolution based on the settings selected from the memory.
